(19) United States
(12) Patent Application Publication
(10) Pub. No.: US 2026/0106330 A1
(43) Pub. Date: Apr. 16, 2026

(54) BATTERY PACK

(71) Applicant: SAMSUNG SDI CO., LTD., Yongin-si (KR)

(72) Inventor: Sang Hun PARK, Yongin-si (KR)

(21) Appl. No.: 19/295,859

(22) Filed: Aug. 11, 2025

(30) Foreign Application Priority Data
Oct. 15, 2024 (KR) 10-2024-0140471

(51) Int. Cl. H01M 50/503; H01M 50/213; H01M 50/262

(52) U.S. Cl. CPC H01M 50/503; H01M 50/213; H01M 50/262

(57) ABSTRACT

The present disclosure relates to a battery pack, and a technical object of the present disclosure is to provide a battery pack in which vibrations and a stress applied to a busbar are dispersed and of which the durability is improved. To this end, the present disclosure provides a battery pack including a first battery module, a second battery module located in a first direction from the first battery module, one or more busbars each of which includes a bent portion having a bent shape, is disposed to extend in the first direction, and is electrically connected to an electrode terminal of the first battery module and an electrode terminal of the second battery module, and a substrate located in a second direction from the first battery module and the second battery module and coupled to the busbar.

### CROSS-REFERENCE TO RELATED APPLICATION

The present application claims priority to and the benefit of Korean Patent Application No. 10-2024-0140471, filed on Oct. 15, 2024, in the Korean Intellectual Property Office, the entire disclosure of which is incorporated herein by reference.

### BACKGROUND

### 1. Field of the Invention

The present disclosure relates to a battery pack.

### 2. Discussion of Related Art

Secondary batteries are batteries that can be charged and discharged, unlike primary batteries that cannot be charged. Low-capacity secondary batteries are used in small portable electronic devices such as smartphones, feature phones, notebook computers, digital cameras, and camcorders. Large-capacity secondary batteries are widely used as power sources for driving motors of hybrid vehicles, electric vehicles, etc. and for power storage. A secondary battery includes a positive electrode and a negative electrode, a case accommodating the electrode assembly, an electrode terminal connected to the electrode assembly, etc.

A secondary battery may be used as a battery pack in which a plurality of unit battery cells are connected in series and/or in parallel are formed in order to provide a high-energy density. The battery pack may be formed such that electrode terminals of the plurality of unit batteries are connected to each other to provide a desired amount of electric power. The battery may be used, for example, a high-power secondary battery for an electric vehicle.

The information in this section is disclosed for the technology that forms the background of the present disclosure is only intended to improve understanding of the background of the present disclosure. As such, this section may include information that does not constitute the related art.

### SUMMARY OF THE DISCLOSURE

The present disclosure is directed to a battery pack in which vibrations and a stress applied to a busbar are dispersed, with the durability of the battery pack being improved.

These and other aspects and features of the present disclosure will be described in or will be apparent from the following description of embodiments of the present disclosure.

In accordance with one aspect of the present disclosure, there is provided a battery pack including a first battery module, a second battery module positioned in a first direction from the first battery module, a bus bar including a bent portion having a bent shape, the bus bar being disposed to extend in the first direction, and the bus bar being electrically connected to an electrode terminal of the first battery module and an electrode terminal of the second battery module, and a substrate extending from the first battery module and the second battery module in the second direction and coupled to the busbar.

Each of the first battery module and the second battery module may include one or more battery cells, a housing in which the one or more battery cells are accommodated, a busbar holder disposed in the second direction from the one or more battery cells, and the electrode terminal that is electrically connected to the one or more battery cells, extends toward the busbar holder, is in contact with the busbar, and includes a positive electrode terminal and a negative electrode terminal.

The busbar may include a positive busbar that extends in the first direction and electrically connects the positive electrode terminal of the first battery module and the positive electrode terminal of the second battery module and a negative busbar that extends in the first direction and electrically connects the negative electrode terminal of the first battery module and the negative electrode terminal of the second battery module.

The busbar may include a busbar body extending in the first direction, a first bent portion formed by a first portion of the busbar body that is bent in the second direction, the first bent portion being in contact with the electrode terminal of the first battery module in the second direction, a second bent portion formed by a second portion of the busbar body that is bent in the second direction, the second bent portion being in contact with the electrode terminal of the second battery module in the second direction, a third bent portion between the first bent portion and the second bent portion, the third bent portion being formed by a third portion of the busbar body that is bent in a third direction, and a substrate coupling part formed on at least one side of the first bent portion and the second bent portion to protrude in the second direction, the substrate coupling part being coupled to the substrate.

The busbar body may include a first body located between the first bent portion and the third bent portion and extends in the first direction, a second body located between the second bent portion and the third bent portion and extends in the first direction, with a separation space formed between the first body and the second body.

The first bent portion may include a first flat portion continuously formed from the busbar body and formed in a shape which is flat in the first direction and the third direction, a second flat portion which is disposed to face the first flat portion with a second distance therebetween in the second direction and is in contact with the electrode terminal of the first battery module, and an elastic bent portion which is continuously formed between the first flat portion and the second flat portion and has a curved shape which is convex in the first direction or the third direction.

The first bent portion may further include a fastening hole passing through the first flat portion and the second flat portion in the second direction and to which a first fastening member is fastened.

The first fastening member may include a fastening body fastened to the first bent portion and the electrode terminal of the first battery module and a head having a width greater than a width of the fastening body, wherein the fastening hole may include a first fastening hole formed in the first flat portion and having a width that allows the head of the fastening body to pass through the first fastening hole and a second fastening hole formed in the second flat portion and having a width that is less than a width of the head.

The third bent portion may include a bent end portion spaced a third distance from the first body and the second body in the third direction extending in the first direction, a first curved portion continuously formed between the bent end portion and the first body and curved in the first direction, and a second curved portion continuously formed between the bent end portion and the second body curved in the first direction.

The first curved portion and the second curved portion may be formed in S shapes and are symmetric to each other.

The first curved portion may include a first semicircular curved portion continuously formed from the first body and having a curved shape which is convex in the first direction and a second semicircular curved portion continuously formed between the first semicircular curved portion and the bent end portion and having a curved shape which is convex in a direction opposite to the first direction.

Each of the first semicircular curved portion and the second semicircular curved portion may be curved in a semicircular shape having a diameter greater than or equal to two times and less than or equal to five times of a thickness of the busbar.

The third bent portion may include a first curved arc portion continuously formed from the first body and having a curved portion which is convex in the first direction and a second curved arc portion continuously formed between the first curved arc portion and the second body and having a curved shape which is convex in a direction opposite to the first direction.

The busbar may be formed from a bent board, the busbar body may be seated on the busbar holder of the first battery module and the busbar holder of the second battery module in the second direction such that a surface of the board extends in the third direction, and at least one side of the first bent portion and the second bent portion may be seated on at least one side of the electrode terminal of the first battery module and the electrode terminal of the second battery module in the second direction.

The busbar holder may be supported and stood up by a width in the third direction of the third bent portion.

The battery pack may further include a connecting member which is coupled to the substrate to thereby form an insertion space between the connecting member and the substrate, with the substrate coupling part being slidably inserted into the insertion space.

The connecting member may include a facing body disposed to face the substrate in the third direction, a protruding portion that protrudes from an edge portion of the facing body in the first direction toward the substrate and in which the insertion space portion is formed between the facing body and the substrate, a plurality of fixed legs formed to protrude from the protruding portion toward the substrate and fitted to the substrate, and an insertion hole that is formed to be open between the edge portion of the facing body in the second direction and the substrate and into which the substrate coupling part is inserted.

The connecting member may further include a first hole that passes through the facing body and to which a second fastening member is fastened, wherein the second fastening member may pass through and be fastened to the first hole, a second hole formed in the substrate coupling part, and a third hole formed in the substrate.

The connecting member may further include a latching hole formed to pass through the protruding portion in the first direction and open to the insertion space portion, wherein the substrate coupling part may include an elastic tong portion having a tong shape of which a width is elastically variable in the first direction, the elastic tong portion being inserted into the insertion space portion through the insertion hole and a latch protrusion protruding from the elastic tong portion in the first direction and caught in the latch hole with the elastic tong portion is inserted into the insertion space portion.

The busbar may further include a holder coupling part that protrudes from at least one side of the first bent portion and the second bent portion in a direction opposite to the second direction, and the holder coupling part being fitted into a guide hole formed in at least one side of the busbar holder of the first battery module and the busbar holder of the second battery module.

### BRIEF DESCRIPTION OF THE DRAWINGS

The drawings attached to this specification illustrate some embodiments of the present disclosure and further describe aspects and features of the present disclosure together with the detailed description of the present disclosure. However, the present disclosure is not limited to the embodiments set forth in drawings.

FIG. 1 is a schematic perspective view of a battery pack according to a first embodiment of the present disclosure;

FIG. 2 is a perspective view of the battery pack according to the first embodiment of the present disclosure in a direction different from that in FIG. 1;

FIG. 3 is a front view of the battery pack depicted in FIG. 1;

FIG. 4 is a plan view of the battery pack depicted in FIG. 1;

FIG. 5 is a schematic exploded perspective view illustrating main parts of the battery pack according to the first embodiment of the present disclosure;

FIG. 6 is a schematic exploded perspective view illustrating the main parts of the battery pack according to the first embodiment of the present disclosure;

FIG. 7 is a schematic perspective view illustrating a battery pack according to a second embodiment of the present disclosure;

FIG. 8 a perspective view illustrating the battery pack according to the second embodiment of the present disclosure in a different direction from FIG. 7;

FIG. 9 is a schematic perspective view illustrating a busbar according to the first embodiment of the present disclosure;

FIG. 10 is a perspective view illustrating the busbar according to the first embodiment of the present disclosure in a direction different from that in FIG. 9;

FIG. 11 is a schematic rear view illustrating the busbar according to the first embodiment of the present disclosure;

FIG. 12 is a schematic plan view illustrating the busbar according to the first embodiment of the present disclosure;

FIG. 13 is a schematic plan view illustrating main parts of the busbar according to the first embodiment of the present disclosure;

FIG. 14 is an enlarged view illustrating portion A of FIG. 1;

FIG. 15 is a schematic rear view illustrating main parts of the potion illustrated in FIG. 14;

FIG. 16 shows a state in which a first fastening member is temporarily fastened;

FIG. 17 is a schematic perspective view illustrating a state in which a connecting member is coupled to a substrate according to the first embodiment of the present disclosure;

FIG. 18 is a view of an assembly structure of the busbar and the substrate according to the first embodiment of the present disclosure;

FIG. 19 is a schematic perspective view of a busbar according to the second embodiment of the present disclosure;

FIG. 20 is a schematic perspective view of one example in which the busbar according to the first embodiment and the busbar according to the second embodiment of the present disclosure are arrayed in the first direction;

FIG. 21 is a schematic perspective view of a busbar according to a third embodiment of the present disclosure;

FIG. 22 is a schematic perspective view of a busbar according to a fourth embodiment of the present disclosure;

FIG. 23 is a schematic perspective view of one example in which the busbar according to the third embodiment and the busbar according to the fourth embodiment of the present disclosure are arrayed in a first direction;

FIG. 24 is a schematic perspective view of a busbar according to a fifth embodiment of the present disclosure;

FIG. 25 is a schematic perspective view of a busbar according to a sixth embodiment of the present disclosure;

FIG. 26 is a schematic perspective view illustrating a state in which a connecting member is coupled to a substrate according to the second embodiment of the present disclosure; and

FIG. 27 is a view of an assembly structure of the busbar according to the fifth embodiment or the sixth embodiment of the present disclosure and the connecting member according to the second embodiment of the present disclosure.

### DETAILED DESCRIPTION OF EXEMPLARY EMBODIMENTS

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Any numerical range disclosed and/or recited herein includes all sub-ranges of the same numerical precision subsumed within the recited range. For example, a range of “1.0 to 10.0” includes all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an element is referred to as being arranged (or located or positioned) on the “above (or below)” or “on (or under)” a component, it may mean that the element is placed in contact with the upper (or lower) surface of the component and may also mean that another component may be interposed between the component and any element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. Further, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

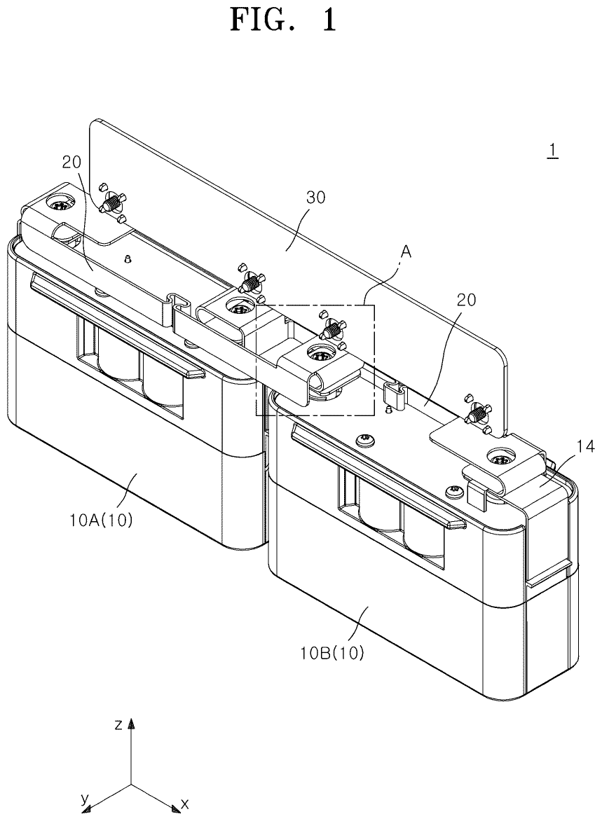

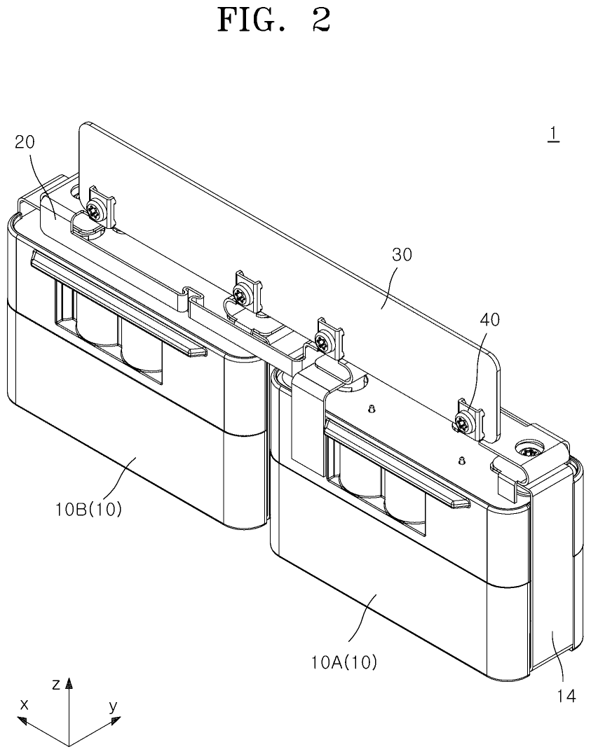

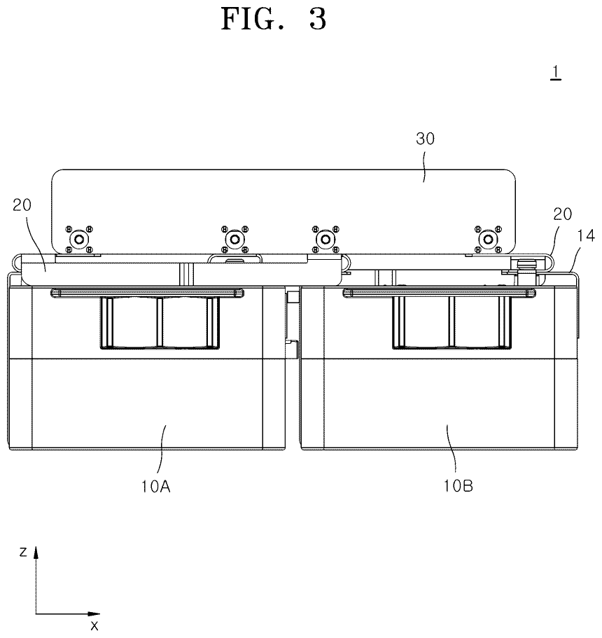

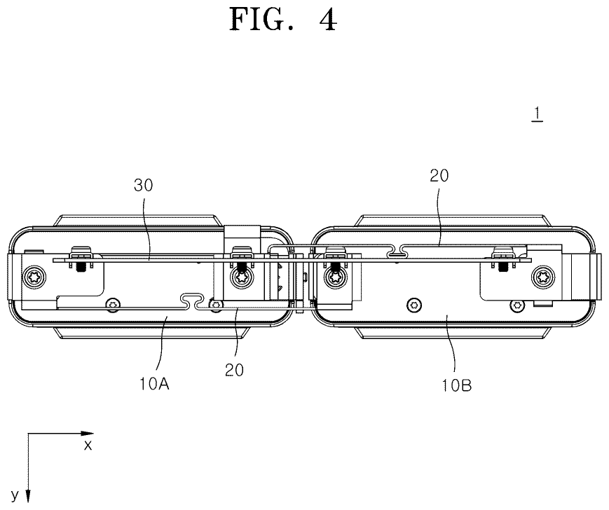

FIG. 1 is a schematic perspective view of a battery pack according to a first embodiment of the present disclosure, and FIG. 2 is a perspective view of the battery pack according to the first embodiment of the present disclosure in a direction different from that in FIG. 1. FIG. 3 is a front view of the battery pack shown in FIG. 1, and FIG. 4 is a plan view of the battery pack shown in FIG. 1.

Hereinafter, for convenience in the description, shapes and arrangement relationships of components will be described based on an x direction, a z direction, and a y direction as illustrated in FIG. 1. A first direction may correspond to the x direction, a second direction may correspond to the z direction, and a third direction correspond to the y direction. In FIG. 1, the x direction is a left-right direction, the y direction is a front-rear direction, the z direction is a vertical direction. When the first direction is referred, the term is not limited to the one particular direction, as a description which is more helpful to describe content may be adopted among the first direction, the x direction, the left-right direction, or the right direction. Accordingly, the first direction will be interchangeably used with the x direction, the left-right direction, or the right direction. In addition, the second direction will be interchangeably used with the z direction, the vertical direction, or the upward direction, and the third direction will be interchangeably used with the y direction, the front-rear direction, or the front direction.

Referring to FIGS. 1 to 4, a battery pack 1 according to the first embodiment of the present disclosure may include a plurality of battery modules 10, a busbar 20, and a substrate 30.

The plurality of battery modules 10 include a first battery module 10A and a second battery module 10B. The second battery module 10B is located in the first direction (x direction) relative to the first battery module 10A. The first battery module 10A and the second battery module 10B may be arrayed side by side in the first direction (x direction).

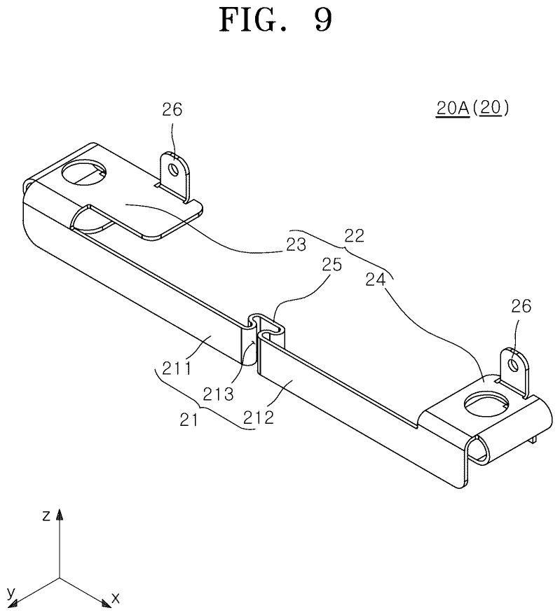

Each of the first battery module 10A and the second battery module 10B may have a substantially quadrangular column shape with a small thickness in the front-rear direction (y direction). In other words, each of the first battery module 10A and the second battery module 10B may have a quadrangular column shape with a flat surface in the front-rear direction. An upper surface of a quadrangular column may have a rectangular shape with a length in the left-right direction that is greater than a width in the front-rear direction. The battery pack 1 having the shape of the battery module 10 and the array of the battery modules 10 may be called a cartridge type battery pack 1. The busbar 20 electrically connects electrode terminals 14 provided on the battery modules 10. The busbar 20 is disposed to extend in the first direction (x direction) and is electrically connected to an electrode terminal 14 of the first battery module 10A and an electrode terminal 14 of the second battery module 10B. The busbar 20 includes a bent portion 22 (see FIG. 9) having a bent shape. The busbar 20 according to the embodiment of the present disclosure may be provided as one busbar 20 or as a plurality of busbars 20 as necessary.

The substrate 30 is located in the second direction (z direction) of the first battery module 10A and the second battery module 10B and coupled to the busbar 20. The substrate 30 may have a flat rectangular board shape and may be disposed to cross between the first battery module 10A and the second battery module 10B and to stand upright on the first battery module 10A and the second battery module 10B in the vertical direction (z direction). The battery modules 10, the busbar 20, and the substrate 30 may be disposed to be stacked from the bottom up. That is, the busbar 20 may be disposed on (in the z direction) the first battery module 10A and the second battery module 10B, and the substrate 30 may be disposed on (in the z direction) of the busbar 20.

The busbar 20 may be coupled to the electrode terminals 14 of the battery module 10 and thereby fixed to a set location on the battery module 10. The substrate 30 may be coupled to the busbar 20 and thereby fixed to a set location on the busbar 20. The battery pack 1 according to the present disclosure may be implemented as the cartridge type battery pack 1 having a substantially quadrangular column shape that is flat in the front-rear direction (y direction) by the arrangement and the shapes of the battery modules 10, the busbar 20, and the substrate 30.

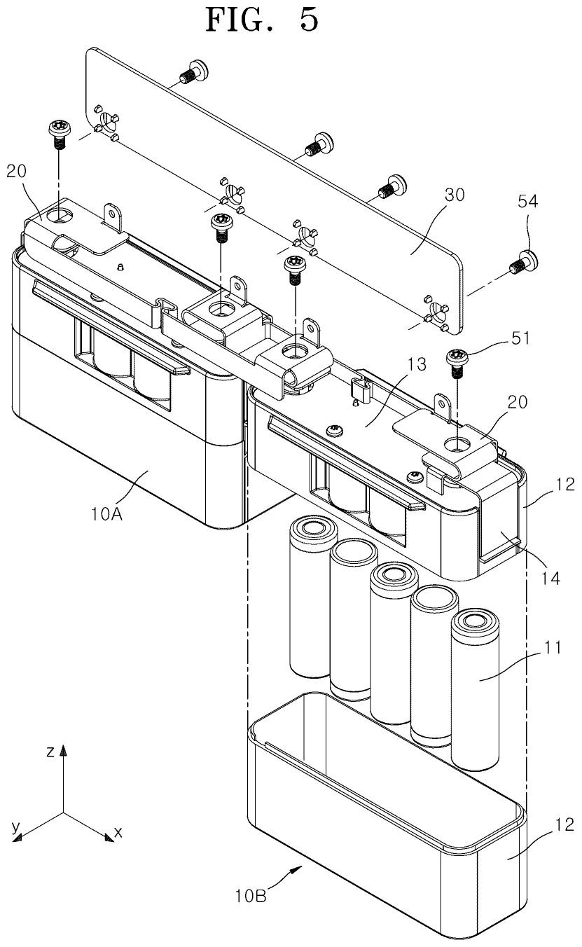

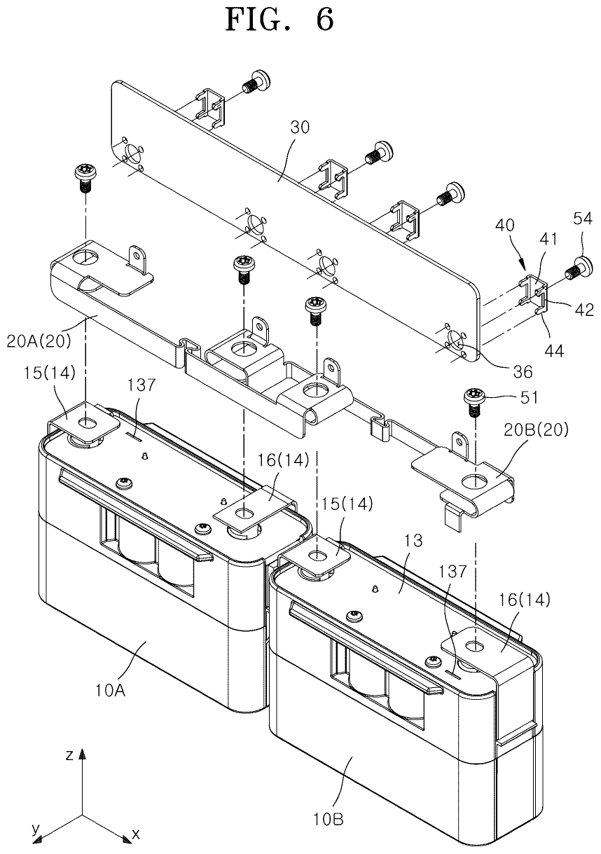

FIG. 5 is an exploded perspective view illustrating main parts of the battery pack according to the first embodiment of the present disclosure, and FIG. 6 is an exploded perspective view illustrating the main parts of the battery pack according to the first embodiment of the present disclosure disassembled in a different way than is shown in FIG. 5.

Referring to FIGS. 5 and 6, the battery modules 10A and 10B may each include a battery cell 11, a housing 12, a busbar holder 13, and the electrode terminal 14.

The battery cell 11 may be provided as one or more battery cells 11. The battery cell 11 may function as a unit structure that stores power and supplies power in the battery pack 1. Hereinafter, a cylindrical lithium-ion secondary battery will be described as an example of the battery cell 11. However, the present disclosure is not limited thereto, and the battery cell 11 may be, for example, a lithium polymer battery or prismatic battery.

Although it is illustrated that the battery can of the battery cell 11 has a circular shape in the drawings, the present disclosure is not limited thereto. The can (case) may have any one of various shapes such as a prismatic shape and a pouch shape. In addition, the battery can may be formed of a metal such as aluminum, an aluminum alloy, steel coated with nickel, or the like, or a laminate film or plastic forming a pouch, etc.

As illustrated in FIG. 5, the battery cell 11 may have a cylindrical shape, and a plurality of battery cells 11 may be arrayed in the left-right direction (x direction). Accordingly, each of the first battery module 10A and the second battery module 10B may have a rectangular column shape of which a length in the left-right direction (x direction) is greater than a length in the front-rear direction (y direction). The housing 12 may have a container shape in which a plurality of the battery cells 11 are accommodated.

The busbar holder 13 may be disposed on the battery cell 11. At least a part of an upper portion of the housing 12 may have an open shape, and the busbar holder 13 may be disposed on the housing 12 to cover an upper surface of the battery cell 11. The busbar 20 may be seated on an upper surface of the busbar holder 13, and a plurality of busbars 20 may be arrayed in the left-right direction (x direction).

The electrode terminal 14 may be electrically connected to the battery cell 11, may extend upward from the busbar holder 13, and may be in contact with the busbar 20. The electrode terminal 14 may be provided as a positive electrode terminal 15 or negative electrode terminal 16. The positive electrode terminal 15 may be electrically connected to a positive electrode of one or the plurality of battery cells 11. The negative electrode terminal 16 may be electrically connected to a negative electrode of one or the plurality of battery cells 11.

The positive electrode terminal 15 may be located at a left side (in an-x direction) of each of the first battery module 10A and the second battery module 10B. In the description herein, the-x direction is a direction opposite to the x direction arrow points in the drawings. In a state in which the first battery module 10A and the second battery module 10B are arrayed in the left-right direction (x direction), the positive electrode terminals 15 of the first battery module 10A and the second battery module 10B may be spaced apart from each other.

The negative electrode terminal 16 may be disposed at a right side (in an x direction) of each of the first battery module 10A and the second battery module 10B. In the state in which the first battery module 10A and the second battery module 10B are arrayed in the left-right direction (x direction), the negative electrode terminals 16 of the first battery module 10A and the second battery module 10B may be spaced apart from each other.

The busbar 20 may be divided into a positive busbar 20A and a negative busbar 20B. The positive busbar 20A may extend in the left-right direction (x direction) and may electrically connect the positive electrode terminals 15 of the first battery module 10A and the second battery module 10B. The negative busbar 20B may extend in the left-right direction (x direction) and may electrically connect the negative electrode terminals 16 of the first battery module 10A and the second battery module 10B.

The positive busbar 20A may have a length extending from the positive electrode terminal 15 of the first battery module 10A to the positive electrode terminal 15 of the second battery module 10B in the left-right direction (x direction). A left end of the positive busbar 20A may be seated on the positive electrode terminal 15 of the first battery module 10A. A right end of the positive busbar 20A may be seated on the positive electrode terminal 15 of the second battery module 10B. A middle portion of the positive busbar 20A located between the left end and the right end of the positive busbar 20A may be seated on the busbar holder 13.

The negative busbar 20B may have a length extending from the negative electrode terminal 16 of the first battery module 10A to the negative electrode terminal 16 of the second battery module 10B in the left-right direction (x direction). A left end of the negative busbar 20B may be seated on the negative electrode terminal 16 of the first battery module 10A. A right end of the negative busbar 20B may be seated on the negative electrode terminal 16 of the second battery module 10B. A middle portion of the negative busbar 20B located between the left end and the right end of the negative busbar 20B may be seated on the busbar holder 13.

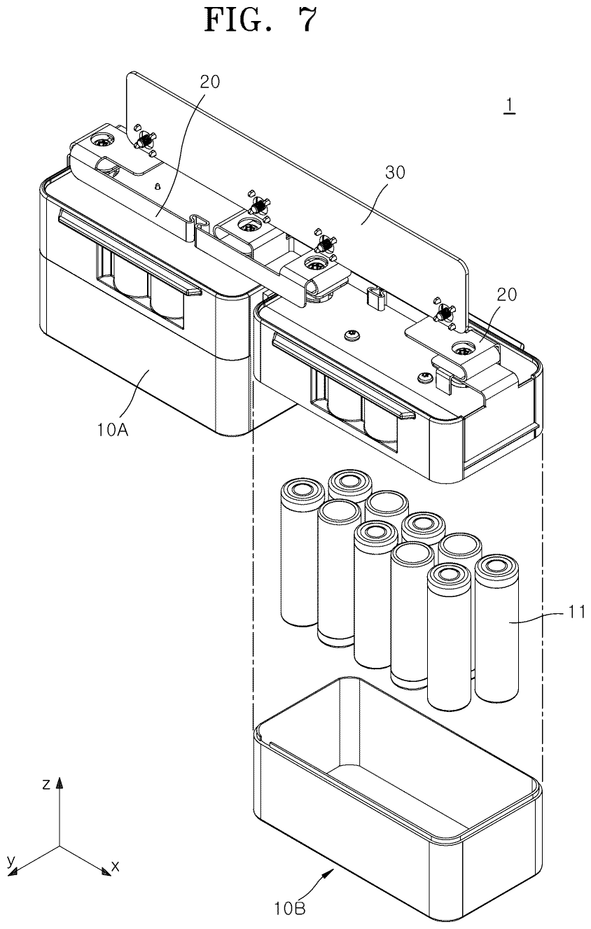

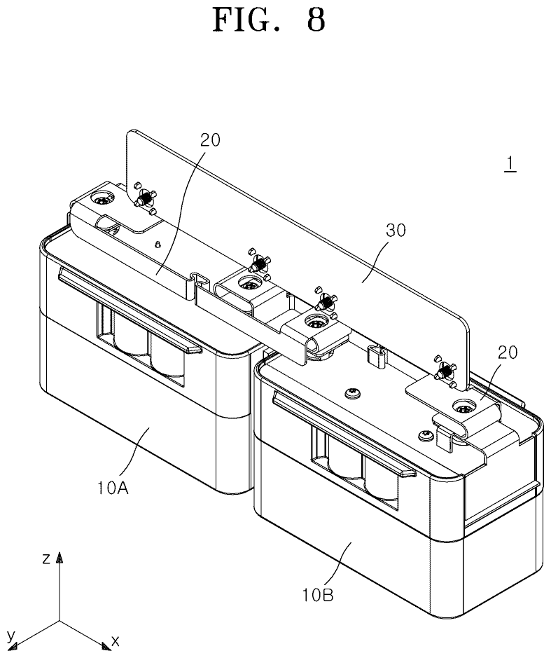

FIG. 7 is a schematic perspective view of a battery pack according to a second embodiment of the present disclosure, and FIG. 8 a perspective view of the battery pack according to the second embodiment of the present disclosure in a direction different from that in FIG. 7.

Referring to FIGS. 7 and 8, like the battery pack 1 according to the first embodiment of the present disclosure illustrated in FIGS. 1 to 4, a battery pack 1 according to the second embodiment of the present disclosure may include a plurality of battery modules 10, a busbar 20, and a substrate 30. Each of a first battery module 10A and a second battery module 10B of the battery pack 1 according to the second embodiment of the present disclosure may include a battery cell 11, a housing 12, a busbar holder 13, and an electrode terminal 14 like the first battery module 10A and the second battery module 10B of the battery pack 1 according to the first embodiment of the present disclosure illustrated in FIGS. 5 and 6.

As illustrated in FIG. 5, battery cells 11 of a battery pack 1 of the present disclosure may have the cylindrical shape, and the plurality of battery cells 11 may be arrayed in the left-right direction (x direction). Similarly, as illustrated in FIG. 7, the battery cell 11 of the battery pack 1 of this embodiment may have a cylindrical shape, and a plurality of battery cells 11 may be arrayed in the left-right direction (x direction). The battery cells 11 of this embodiment may be arrayed in a plurality of rows in the front-rear direction (y direction). Thus, according to the present disclosure, the battery cells 11 may be arrayed in one row in the front-rear direction (y direction) as illustrated in FIG. 5 or arrayed in two or more plurality of rows as illustrated in FIG. 7.

In addition, although not illustrated in the drawings, further battery modules 10 in addition to the first battery module 10A and the second battery module 10B may also be further disposed in the left-right direction (x direction). In the battery pack 1 of the present disclosure, when a further battery module 10 is electrically connected to the busbar 20 and the substrate 30, the battery pack 1 may be implemented in a state in which three or more battery modules 10 are arrayed in the left-right direction (x direction).

Thus, a battery module 10 according to the present disclosure is not limited to the plurality of battery cells 11 being arrayed in the left-right direction (x direction) as illustrated in FIG. 5. Rather, as the plurality of battery cells 11 may be arrayed to form the plurality of rows in the front-rear direction (y direction) as illustrated in FIG. 7, and the output power and energy capacity of the battery pack 1 may be further increased proportionally with the increase in the number of rows of the battery cells 11. In addition, the output power and energy capacity of the battery pack 1 may be further increased proportionally by increasing the number of the battery modules 10.

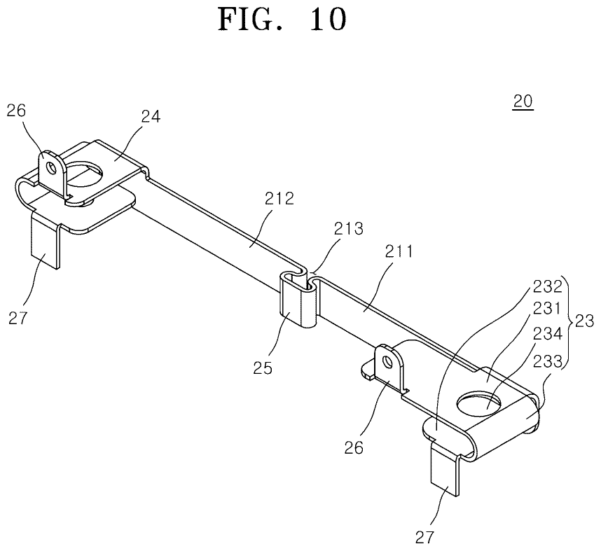

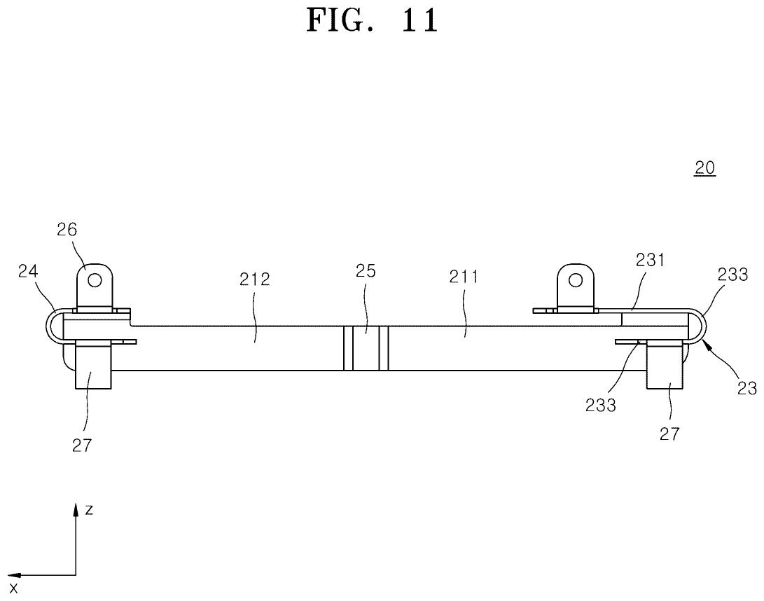

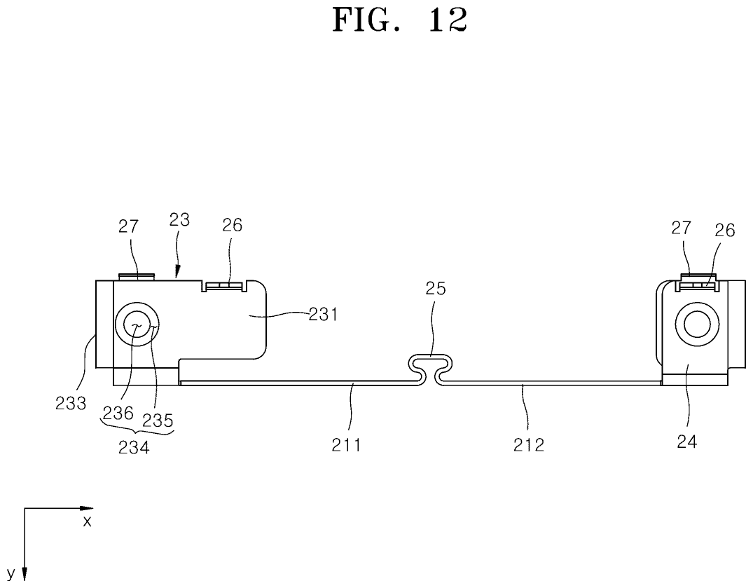

FIG. 9 is a schematic perspective view of the busbar according to the first embodiment of the present disclosure, and FIG. 10 is a perspective view of the busbar according to the first embodiment of the present disclosure in a direction different from that shown in FIG. 9. FIG. 11 is a schematic rear view of the busbar according to the first embodiment of the present disclosure, and FIG. 12 is a schematic plan view illustrating the busbar according to the first embodiment of the present disclosure.

Referring to FIGS. 9 to 12, the busbar 20 according to the first embodiment of the present disclosure may include a busbar body 21, the bent portion 22, a substrate coupling part 26, and a holder coupling part 27.

The busbar 20 according to the present disclosure may be made by cutting a board having a flat board shape into a shape including the busbar body 21, the bent portion 22, the substrate coupling part 26, and the holder coupling part 27. Then boundary portions between the busbar body 21, the bent portion 22, the substrate coupling part 26, and the holder coupling part 27 and a portion corresponding to the bent portion 22 are bent. The board may be formed of a conductive, flexible, and elastic material such as metal.

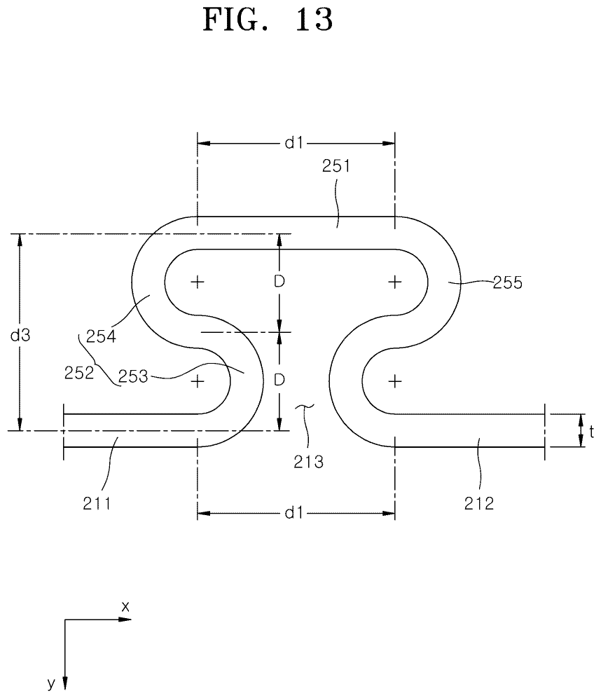

The busbar body 21 may be formed to extend in the left-right direction (x direction). The busbar body 21 may have a shape in which a surface of the board having a flat band shape stands up in the front-rear direction (y direction). The busbar body 21 may include a first body 211, a second body 212, and a separation space 213. FIG. 13 is a schematic plan view of main parts of the busbar according to the first embodiment of the present disclosure.

Referring to FIGS. 9 to 13, the first body 211 may be located between a first bent portion 23 and a third bent portion 25 and may extend in the left-right direction (x direction). The second body 212 may be located between a second bent portion 24 and the third bent portion 25 and may extend in the left-right direction (x direction). The separation space 213 may be formed with a first distance d1 between the first body 211 and the second body 212.

The third bent portion 25 is formed between the first body 211 and the second body 212. The first body 211 and the second body 212 may be elastically and moved relative to each other by the third bent portion 25 (which will be described below). The first body 211 and the second body 212 may be relatively moved by the third bent portion 25 in the left-right direction (x direction) and the front-rear direction (y direction). The first body 211 and the second body 212 may be moved to be spaced apart from each other by the third bent portion 25. As the first body 211 and the second body 212 are disposed to be spaced apart from each other in the left-right direction (x direction), the first body 211 and the second body 212 may also be moved to be close to each other.

The bent portion 22 may be provided as a plurality of bent portions 22 including the first bent portion 23, the second bent portion 24, and the third bent portion 25. A left end portion of the busbar body 21 may be bent in the vertical direction (z direction) to form the first bent portion 23. A right end portion of the busbar body 21 may be bent in the vertical direction (z direction) to form the second bent portion 24. A middle portion of the busbar body 21 located between the first bent portion 23 and the second bent portion 24 is bent in the front-rear direction (y direction) to form the third bent portion 25.

The first bent portion 23 and the second bent portion 24 may be formed at both end portions of the busbar body 21 in the left-right direction (x direction). The first bent portion 23 and the second bent portion 24 may be seated on the electrode terminal 14 of the first battery module 10A and the electrode terminal 14 of the second battery module 10B, respectively. The first and second bent portions 23 and 24 may be fastened thereto by first fastening members 51.

The busbar body 21 may be seated on upper surfaces of the busbar holder 13 of the first battery module 10A and the busbar holder 13 of the second battery module 10B in a state in which the board surface extends upward in the front-rear direction (y direction). At the same time, the first bent portion 23 and the second bent portion 24 may be seated on upper surfaces of the electrode terminal 14 of the first battery module 10A and the electrode terminal 14 of the second battery module 10B, respectively.

When the busbar 20 is used as the positive busbar 20A, one of the first bent portion 23 and the second bent portion 24 may be coupled to the positive electrode terminal 15 of the first battery module 10A, and the other of the first bent portion 23 and the second bent portion 24 may be seated on and coupled to the positive electrode terminal 15 of the second battery module 10B. Accordingly, the positive electrode terminal 15 of the first battery module 10A and the positive electrode terminal 15 of the second battery module 10B may be electrically connected to each other by the busbar 20.

When the busbar 20 is used as the negative busbar 20B, one of the first bent portion 23 and the second bent portion 24 may be seated on and coupled to the negative electrode terminal 16 of the first battery module 10A, and the other of the first bent portion 23 and the second bent portion 24 may be seated on and coupled to the negative electrode terminal 16 of the second battery module 10B. Accordingly, the negative electrode terminal 16 of the first battery module 10A and the negative electrode terminal 16 of the second battery module 10B may be electrically connected to each other by the busbar 20.

The polarities of the busbars 20A and 20B may be determined according to which is coupled to the positive electrode terminal 15 or the negative electrode terminal 16. Accordingly, in the following descriptions, the positive busbar 20A is described as a first example of the busbar 20, but the descriptions may be equally applicable to the negative busbar 20B.

The terms “first bent portion 23” or “second bent portion 24” may be determined according to which the first bent portion 23 or the second bent portion 24 is coupled to the positive electrode terminal 15 of the first battery module 10A or the positive electrode terminal 15 of the second battery module 10B. Accordingly, in the following descriptions, the first bent portion 23 is described, but the descriptions may be equally applicable to the second bent portion 24.

The first bent portion 23 may include a first flat portion 231, a second flat portion 232, an elastic bent portion 233, and a fastening hole 234.

The first flat portion 231 may be continuously formed with the first body 211. The first flat portion 231 may have a flat shape in the left-right direction (x direction) and in the front-rear direction (y direction). The second flat portion 232 may be disposed to face the first flat portion 231 in the vertical direction (z direction). The second flat portion 232 may have a flat shape in the left-right direction (x direction) and in the front-rear direction (y direction) like the first flat portion 231.

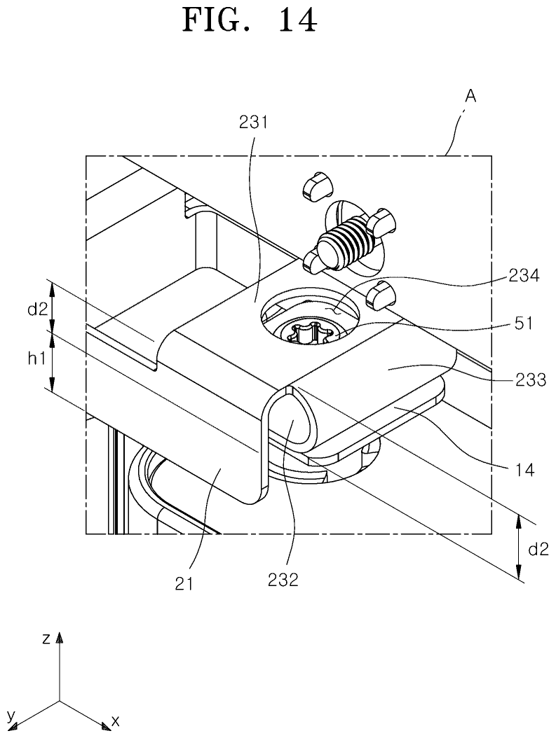

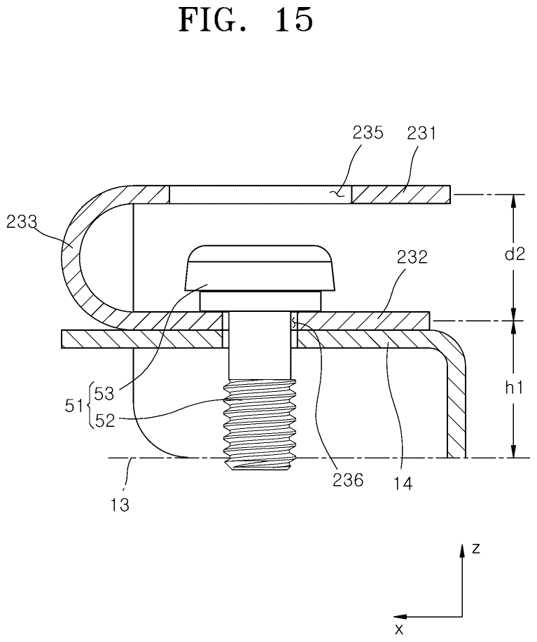

FIG. 14 is an enlarged view of portion A of FIG. 1, and FIG. 15 is a schematic rear view illustrating main parts of the potion illustrated in FIG. 14.

Referring to FIGS. 14 and 15, the second flat portion 232 may be disposed to face the first flat portion 231 with a second distance d2 in the vertical direction (z direction) between the flat portions 231 and 232. The second flat portion 232 may be disposed under the first flat portion 231 and seated on the electrode terminal 14 of the first battery module 10A. In particular, the second flat portion 232 may be in surface contract with the electrode terminal 14 of the first battery module 10A.

The elastic bent portion 233 may be continuously formed between the first flat portion 231 and the second flat portion 232. The elastic bent portion 233 may have a bent shape that is convex in the left-right direction (x direction) or the front-rear direction (y direction). The elastic bent portion 233 may have a height corresponding to the second distance d2.

The busbar body 21, the first flat portion 231, the elastic bent portion 233, and the second flat portion 232 may be continuously connected. The elastic bent portion 233 may be formed between the first flat portion 231 and the second flat portion 232. The first flat portion 231 and the second flat portion 232 may be connected to each other by the elastic bent portion 233 and elastically moved relative to each other by the elastic bent portion 233. In particular, the first flat portion 231 and the second flat portion 232 may be moved by the elastic bent portion 233 in the vertical direction (z direction).

The fastening hole 234 is formed to pass through the first flat portion 231 and the second flat portion 232 in the vertical direction (z direction). That is, the fastening hole 234 may include holes 235 and 236 formed in the first flat portion 231 and the second flat portion 232. A first fastening member 51 may pass through and be fastened to the fastening hole 234 and the electrode terminal 14. The first bent portion 23 may be fixed to the electrode terminal 14 by the first fastening member 51 so that the first bent portion 23 is in close surface contact with the electrode terminal 14. Accordingly, the busbar 20 may be electrically connected to the electrode terminal 14.

The fastening hole 234 may include a first fastening hole 235 formed in the first flat portion 231 and a second fastening hole 236 formed in the second flat portion 232. The second fastening hole 236 may be located below the first fastening hole 235, and the first fastening member 51 may sequentially pass through the first fastening hole 235 and the second fastening hole 236 and may be coupled to the electrode terminal 14.

A bolt member may be used as the first fastening member 51. The first fastening member 51 may include a fastening body 52 and a head 53. The fastening body 52 may include a male thread and may be fastened to the first bent portion 233 and the electrode terminal 14 of the first battery module 10A. The head 53 may have a width greater than that of the fastening body 52 and may be disposed on an upper portion of the fastening body 52.

The first fastening hole 235 may be formed in the first flat portion 231 to have a width allowing the head 53 to pass therethrough. The second fastening hole 236 may be formed in the second flat portion 232 and may have a width smaller than that of the head 53. In particular, the second fastening hole 236 may be formed to have a width which allows the fastening body 52 to pass therethrough and does not allow the head 53 to pass therethrough.

As the second fastening hole 236 has the width smaller than that of the head 53, when the first fastening member 51 is fastened to the first bent portion 23 or the second bent portion 24, the head 53 may contact the second flat portion 232. The head 53 may be in contact with the second flat portion 232 by a force corresponding to a fastening force of the first fastening member 51. As a washer is disposed between the second flat portion 232 and the head 53, the second flat portion 232 may be in closer contact with the head 53.

The upper surface of the electrode terminal 14 may be formed at distance corresponding to a first height h1 from the upper surface of the busbar holder 13. When the first bent portion 23 is seated on and coupled to the electrode terminal 14, the second flat portion 232 may be located at a level corresponding to the first height h1 from the upper surface of the busbar holder 13.

The first flat portion 231 may be located at an upper level corresponding to the second distance d2 from the second flat portion 232. The first flat portion 231 may be connected to the busbar body 21. As the surface of the board has a shape that laterally stands up and lies in the front-rear direction (y direction), the busbar body 21 may have a width in the vertical direction which is the first height h1 plus the second distance d2. For convenience in this description, when the second distance d2 and the first height h1 are set, a thickness of the electrode terminal 14 and a thickness of the first bent portion 23 may be ignored. In actual manufacturing, it is preferable that the thickness of the electrode terminal 14 and the thickness of the first bent portion 23 be considered.

As the first bent portion 23 has a structure in which the first flat portion 231, the elastic bent portion 233, and the second flat portion 232 are connected to each other, the first bent portion 23 may have an elastic deformable force in the vertical direction. In addition, as the busbar body 21 and the first flat portion 231 have a connected structure, the width of the busbar body 21 in the vertical direction may be further increased by the second distance d2, and an allowable current may be further increased by an amount corresponding to the increased width.

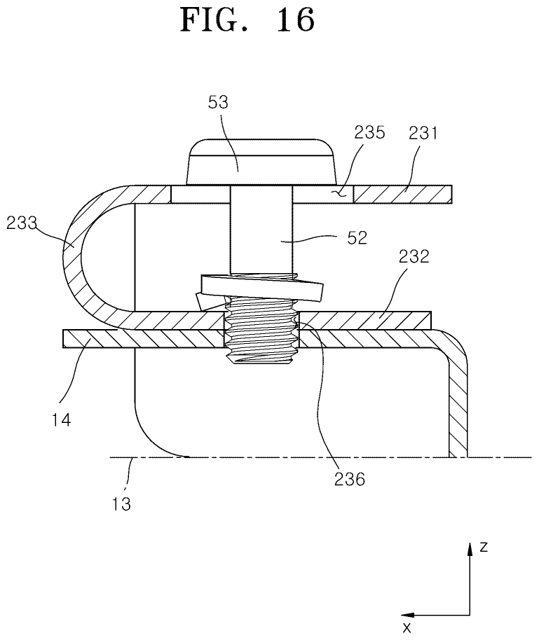

FIG. 16 shows a state in which the first fastening member is temporarily fastened.

FIGS. 14 and 15 show a state in which fastening of the first fastening member 51 is completed. When the first fastening member 51 is assembled to the first bent portion 23, first, as illustrated in FIG. 16, temporary fastening of the first fastening member 51 is made. Then, as illustrated in FIGS. 14 and 15, the fastening of the first fastening member 51 may be completed. In this case, there is a temporary fastening means such that the first fastening member 51 is temporarily fastened to the first bent portion 23 and the electrode terminal 14. In the temporary fastening state, a lower portion of the fastening body 52 may be fastened to the electrode terminal 14 to a depth such that the lower portion passes through the electrode terminal 14. In a state in which the fastening of the first fastening member 51 is completed, the upper portion of the fastening body 52 may be fastened to the electrode terminal 14 to a depth such that the upper portion passes through the electrode terminal 14.

In the state in which the first fastening member 51 is temporarily fastened thereto, the head 53 is exposed to outside of the first bent portion 23 such that a tool may be easily aligned with the head 53. When the first fastening member 51 is temporarily fastened to the first bent portion 23, for accessibility, it is preferable that the head 53 be located at a higher level than the first flat portion 231. Accordingly, the second distance d2 may be restricted in the temporary fastening state of the first fastening member 51.

Referring to FIG. 13, the third bent portion 25 may include a bent end portion 251, a first curved portion 252, and a second curved portion 255.

The bent end portion 251 may be spaced a third distance d3 from the first body 211 and the second body 212 in the front-rear direction (y direction) and formed to extend in the left-right direction (x direction). The bent end portion 251 may have a width in the left-right direction that is the same as the first distance d1, or the bent end portion 251 may have a width in the left-right direction that is different from the first distance d1.

The first curved portion 252 may be continuously formed between the bent end portion 251 and the first body 211. The second curved portion 255 may be continuously formed between the bent end portion 251 and the second body 212. The first curved portion 252 and the second curved portion 255 may be formed to be curved in the left-right direction (x direction). The first curved portion 252 and the second curved portion 255 may be curved in a left direction (x direction) and a right direction (−x direction). And the first curved portion 252 and the second curved portion 255 may be formed in curved shapes, such as an “S”, which are symmetrical to each other.

The first curved portion 252 may include a first semicircular curved portion 253 and a second semicircular curved portion 254. The first semicircular curved portion 253 may be continuously formed from the first body 211 and may have an arc shape which is convex in the right direction (x direction). The second semicircular curved portion 254 may be continuously formed between the first semicircular curved portion 253 and the bent end portion 251 and have an arc shape which is convex in the left direction (−x direction). As noted above, the −x direction is a direction opposite to the x direction illustrated in the drawings.

As an example, each of the first semicircular curved portion 253 and the second semicircular curved portion 254 may be curved in a semicircular shape having a diameter D greater than or equal to two times and smaller than or equal to five times of a thickness t of the busbar 20. More preferably, each of the first semicircular curved portion 253 and the second semicircular curved portion 254 may be curved in a semicircular shape having a diameter D greater than or equal to 7/2 times the thickness t of the busbar 20. In this case, the bent end portion 251 may have the width in the left-right direction that is the same as the first distance d1.

The second curved portion 255 may be disposed in the shape that is symmetrical to that of the first curved portion 252 to face the first curved portion 252 in the left-right direction (x direction). Since the second curved portion 255 has the shape that is symmetrical to that of the first curved portion 252, a description of the second curved portion 255 may be the same as the description of the first curved portion 252. A width of each of the first semicircular curved portion 253 and the second semicircular curved portion 254 may elastically vary in the front-rear direction (y direction). A distance between the first curved portion 252 and the second curved portion 255 may also elastically vary in the left-right direction (x direction). The first body 211 and the second body 212 may be continuously connected to the first curved portion 252 and the second curved portion 255, respectively.

Accordingly, the first body 211 and the second body 212 may be elastically and moved relative to each other by the third bent portion 25. The first body 211 and the second body 212 may be moved by the third bent portion 25 in the left-right direction (x direction) and in the front-rear direction (y direction). And the first body 211 and the second body 212 may be moved to be spaced apart from each other by the third bent portion 25.

In a state in which the surface of the board of the busbar body 21 stands up in the front-rear direction (y direction), the busbar body 21 may be seated on the upper surfaces of the busbar holder 13 of the first battery module 10A and the busbar holder 13 of the second battery module 10B. In this case, the busbar holder 13 may be supported and stood up by the third bent portion 25 having a width in the front-rear direction (y direction). Since the busbar 20 may stand up at any location of the busbar holder 13, the accessibility of the busbar 20 can be improved.

The substrate coupling part 26 may protrude upward (in the z direction) from at least one side of the first bent portion 23 and the second bent portion 24. In particular, the substrate coupling part 26 may be formed to protrude upward from the first flat portion 231. The substrate 30 may be coupled to the substrate coupling part 26 of the first bent portion 23 and the second bent portion 24.

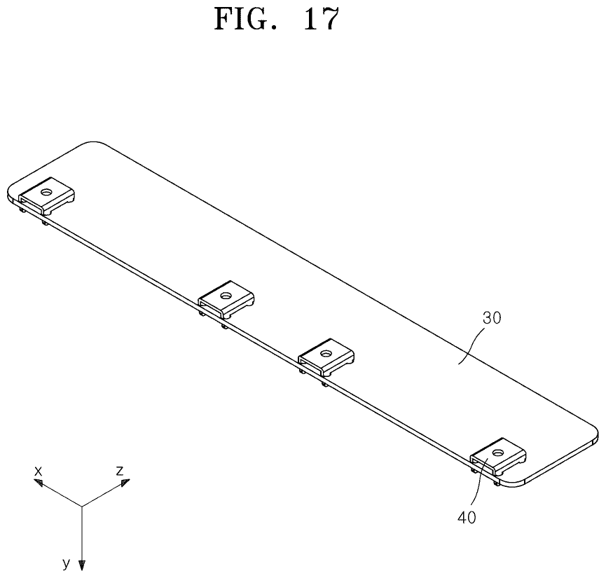

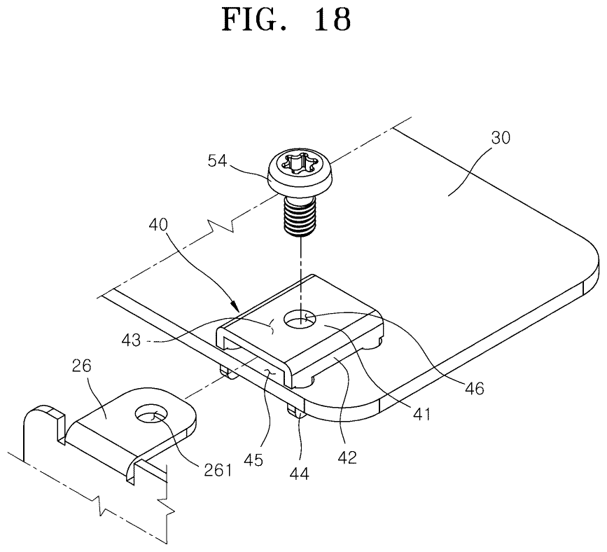

FIG. 17 is a schematic perspective view of a state in which a connecting member is coupled to the substrate according to the first embodiment of the present disclosure, and FIG. 18 is a view of an assembly structure of the busbar and the substrate according to the first embodiment of the present disclosure.

Referring to FIGS. 6, 17, and 18, the battery pack 1 according to the present disclosure may further include a connecting member 40 through which the substrate 30 and the busbar 20 are coupled.

The connecting member 40 may be coupled to the substrate 30, and an insertion space portion 43 into which the substrate coupling part 26 of the busbar 20 is slidably inserted may be formed between the connecting member 40 and the substrate 30. The connecting member 40 according to the first embodiment of the present disclosure may include a facing body 41, a protruding portion 42, a fixed leg 44, an insertion hole 45, and a first hole 46.

The facing body 41 may have an upright flat plate shape and may be disposed to face the substrate 30 in the front-rear direction (y direction). The protruding portion 42 may be formed to protrude from a right end portion and a left end portion of the facing body 41 toward the substrate 30. When the connecting member 40 is coupled to the substrate 30, the protruding portion 42 may face and may be in contact with a front surface or rear surface of the substrate 30. The protruding portion 42 may also be formed to protrude from an upper portion of the facing body 41 toward the substrate 30.

As the protruding portion 42 is formed, the insertion space portion 43 may be formed between the facing body 41 and the substrate 30 to have a width in the front-rear direction (y direction) that corresponds to a protruding width of the protruding portion 42. In particular, the insertion space portion 43 may have the width in the front-rear direction (y direction) corresponding to a thickness of the substrate coupling part 26. The protruding portion 42 may be formed to protrude by the width in the front-rear direction (y direction) that corresponds to the thickness of the substrate coupling part 26.

When the insertion space portion 43 has the width in the front-rear direction (y direction) that corresponds to the thickness of the substrate coupling part 26, the substrate coupling part 26 may be inserted into the insertion space portion 43, with the substrate coupling part 26 thereby coming into contact with the connecting member 40 and the substrate 30 without gaps between the structures. When the connecting member 40 is formed of an electrically conductive material, the substrate coupling part 26 may be stably electrically connected to the connecting member 40. And the substrate coupling part 26 may be stably electrically connected to a contact part (not shown) provided on the substrate 30.

The fixed leg 44 may be formed to protrude from the protruding portion 42 toward the substrate 30 and may be provided as a plurality of fixed legs 44. The fixed legs 44 may be formed on lower and upper portions of a left protruding portion 42 and a right protruding portion 42 such that four fixed legs 44 are provided. The four fixed legs 44 may be fixedly fitted into four holes formed in the substrate 30.

The insertion hole 45 may be formed to be open between a lower end portion of the facing body 41 and the substrate 30. The substrate coupling part 26 may be slidably inserted into the insertion space portion 43 through the insertion hole 45. An upper portion of the substrate coupling part 26 may be formed in a shape having a width in the left-right direction (x direction) that decreases upward to make the substrate coupling part 26 easily insertable into the insertion hole 45. In some examples, the upper portion of the substrate coupling part 26 may have a semicircular shape that is convex upward.

The first hole 46 may be formed to pass through the facing body 41 in the front-rear direction. A second hole 261 may be formed in the substrate coupling part 26. The second hole 261 may be positioned to correspond to the insertion hole 45 in a state in which the substrate coupling part 26 is inserted into the first hole. A third hole 36 may be formed in the substrate 30. The third hole 36 may be formed to correspond to the insertion hole 45. A second fastening member 54 may pass through and be fastened to the first hole 46, the second hole 261, and the third hole 36.

As described above, the substrate coupling part 26 of the busbar 20 may be coupled to the substrate 30 by the connecting member 40 and the second fastening member 54. The substrate coupling part 26, the substrate 30, and the connecting member 40 may come into closer contact with each other in the front-rear direction (y direction) due to the second fastening member 54, and a current may flow stably through the structures. When the second fastening member 54 is formed of an electrically conductive material, the second fastening member 54 may serve as an electrically conductive member that electrically connects the substrate coupling part 26, the substrate 30, and the connecting member 40.

The holder coupling part 27 may protrude downward from at least one side of the first bent portion 23 and the second bent portion 24. The holder coupling part 27 ma protrude downward from the second flat portion 232 toward the busbar holder 13. The holder coupling part 27 may have a length in the vertical direction that is greater than the first height h1 that is a protruding height of the electrode terminal 14.

A lower portion of the holder coupling part 27 may be fitted into a guide hole 137 formed in at least one side of the busbar holder 13 of the first battery module 10A and the busbar holder 13 of the second battery module 10B. As the holder coupling part 27 is fitted into the guide hole 137, the busbar 20 may be easily assembled in a desired set location and direction.

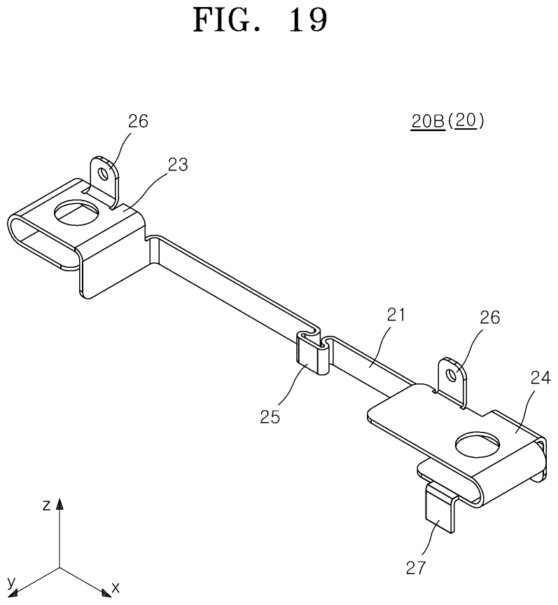

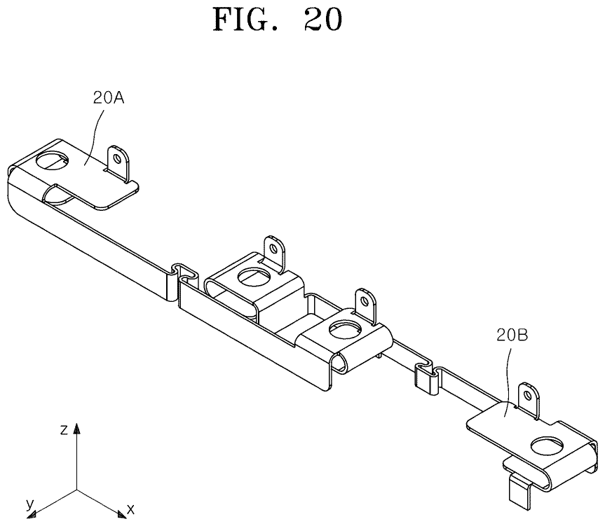

FIG. 19 is a schematic perspective view if the busbar according to the second embodiment of the present disclosure, and FIG. 20 is a schematic perspective view illustrating an example in which the busbar according to the first embodiment and the busbar according to the second embodiment of the present disclosure are arrayed in the first direction.

Referring to FIG. 19, as compared with the busbar 20 according to the first embodiment of the present disclosure illustrated in FIGS. 9 to 12, locations, widths, and curved directions of boundary portions of a busbar body 21, a first bent portion 23, a second bent portion 24, a third bent portion 25, a substrate coupling part 26, and a holder coupling part 27 are partially different. However, the busbar 20 according to the second embodiment of the present disclosure has a structure corresponding to the busbar 20 according to the first embodiment of the present disclosure in that the busbar 20 according to the second embodiment of the present disclosure includes the busbar body 21, the first bent portion 23, the second bent portion 24, the third bent portion 25, the substrate coupling part 26, and the holder coupling part 27, and operational effects of the busbars are also the same. Accordingly, descriptions of aspects of the busbar 20 according to the second embodiment of the present disclosure are the same as descriptions of the busbar 20 according to the first embodiment of the present disclosure.

The busbar 20 according to the first embodiment of the present disclosure may be used as a positive busbar 20A. The busbar 20 according to the second embodiment of the present disclosure may be used as a negative busbar 20B. Conversely, the busbar 20 according to the first embodiment of the present disclosure may be used as a negative busbar 20B, and the busbar 20 according to the second embodiment of the present disclosure may also be used as a positive busbar 20A.

Referring to FIGS. 9, 19, and 20, the positive busbar 20A and the negative busbar 20B may be disposed to form a row extending in the left-right direction (x direction). In this case, the first bent portion 23 and the second bent portion 24 of the positive busbar 20A and the first bent portion 23 and the second bent portion 24 of the negative busbar 20B may be alternately disposed in the left-right direction (x direction). As such, the first bent portion 23 of the negative busbar 20B may be disposed between the first bent portion 23 and the second bent portion 24 of the positive busbar 20A.

Referring to FIGS. 5, 6, 9, and 20, two substrate coupling parts 26 formed on the positive busbar 20A and two substrate coupling parts 26 formed on the negative busbar 20B may be arrayed in the left-right direction (x direction). The substrate coupling parts 26 of the positive busbar 20A and the substrate coupling parts 26 of the negative busbar 20B may be alternately disposed in the left-right direction (x direction).

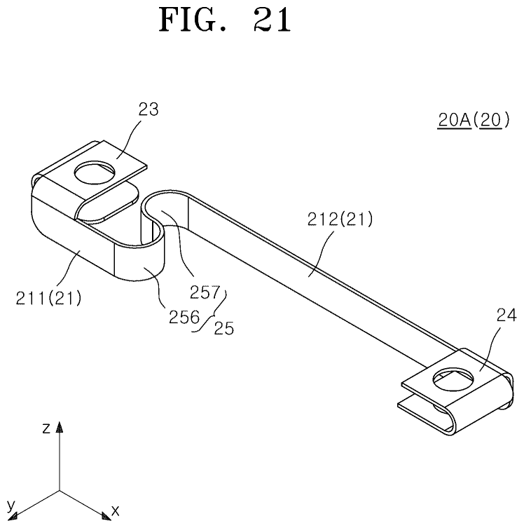

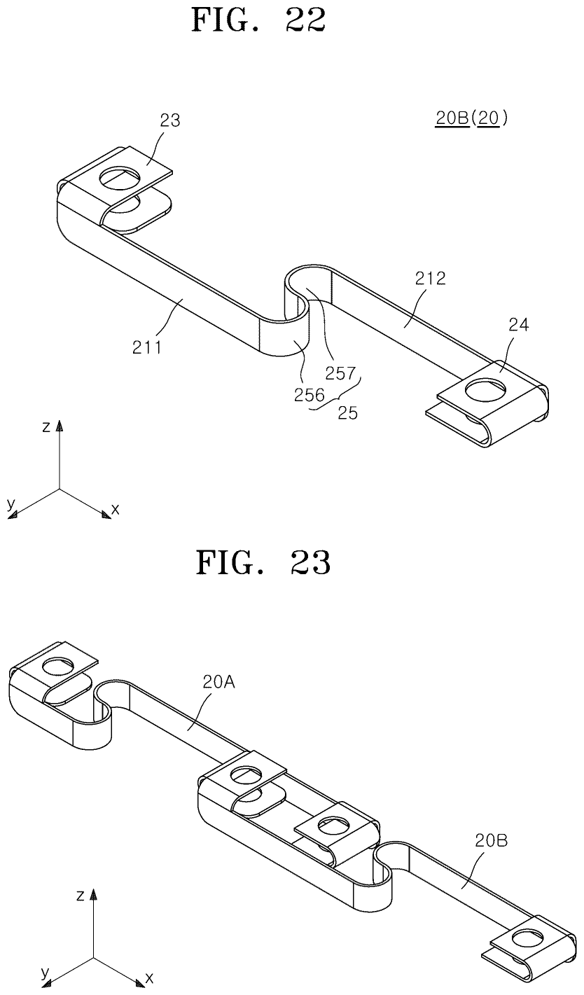

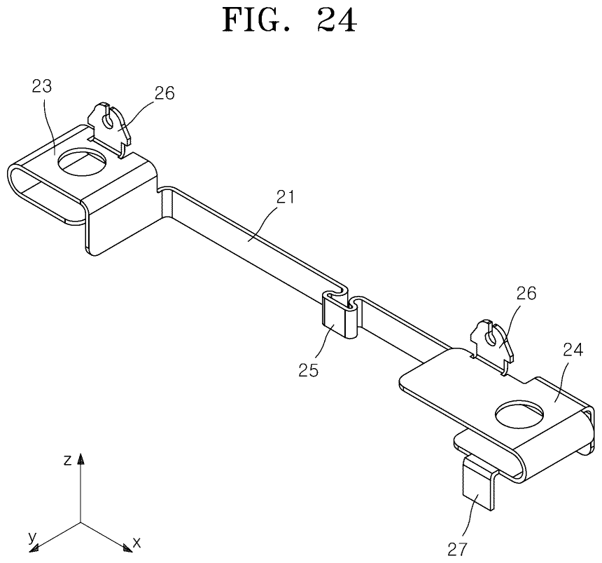

FIG. 21 is a schematic perspective view of a busbar according to a third embodiment of the present disclosure, and FIG. 22 is a schematic perspective view of a busbar according to a fourth embodiment of the present disclosure. FIG. 23 is a schematic perspective view illustrating one example in which the busbar according to the third embodiment and the busbar according to the fourth embodiment of the present disclosure are arrayed in the first direction.

For the busbar 20 according to the third embodiment or the fourth embodiment of the present disclosure shown in FIGS. 21 to 23, descriptions of components that are the same as or corresponding to those of the busbar 20 according to the first embodiment or the second embodiment of the present disclosure will be omitted. But components that are different from those of the busbar 20 according to the first embodiment or the second embodiment of the present disclosure will be described.

Referring to FIG. 21, in the busbar 20 according to the third embodiment of the present disclosure, the shapes of a busbar body 21 and a third bent portion 25 are different as compared to the busbar 20 according to the first embodiment of the present disclosure illustrated in FIGS. 9 to 12.

Referring to FIGS. 9 to 12, in the busbar body 21 of the busbar 20 according to the first embodiment of the present disclosure, the first body 211 and the second body 212 are disposed to form a straight line in the left-right direction (x direction). In addition, the third bent portion 25 of the busbar 20 according to the first embodiment of the present disclosure protrudes between the first body 211 and the second body 212 in the front-rear direction (y direction) and has a symmetrical shape in the left-right direction (x direction). When compared with this, the busbar body 21 of the busbar 20 according to the third embodiment of the present disclosure may have a structure in which a first body 211 and a second body 212 are disposed to be spaced apart from each other in the front-rear direction (y direction). In addition, the third bent portion 25 of the busbar 20 according to the third embodiment of the present disclosure may have a structure including a first curved arc portion 256 and a second curved arc portion 257. The first curved arc portion 256 may be continuously formed from the first body 211 and may have a curved shape that is convex in the right direction. The second curved arc portion 254B may be continuously formed between the first curved arc portion 253B and the second body 212 and may have a curved shape that is convex in the left direction.

The busbar body 21 and the third bent portion 25 of the busbar 20 according to the third embodiment of the present disclosure, the first body 211 and the second body 212 have different positioning in the front-rear direction (y direction). Accordingly, when another component interferes at a location corresponding to one of the first body 211 and the second body 212 or there is a need to avoid the corresponding location, the present embodiment can be effectively applied. For example, when an avoiding target component is positioned at a location corresponding to the second body 212 of the busbar 20 according to the first embodiment of the present disclosure, the busbar 20 according to the third embodiment of the present disclosure in which the second body 212 is located behind the first body 211 can be used.

Referring to FIG. 22, the busbar 20 according to a fourth embodiment of the present disclosure has differences in locations and widths of a busbar body 21 and a third bent portion 25 as compared to the busbar 20 according to the first embodiment of the present disclosure illustrated in FIG. 9. However, the busbar 20 according to the fourth embodiment of the present disclosure has a structure corresponding to the busbar 20 according to the third embodiment of the present disclosure in that the busbar 20 according to the fourth embodiment of the present disclosure includes a busbar body 21, a first bent portion 23, a second bent portion 24, and a third bent portion 25 in the same manner as the busbar 20 according to the third embodiment of the present disclosure, and operational effects thereof are also the same. Accordingly, descriptions of components of the busbar 20 according to the fourth embodiment of the present disclosure may be the same as descriptions of components of the busbar 20 according to the third embodiment of the present disclosure.

The busbar 20 according to the third embodiment of the present disclosure may be used as a positive busbar 20A. The busbar 20 according to the fourth embodiment of the present disclosure may be used as a negative busbar 20B. Conversely, the busbar 20 according to the third embodiment of the present disclosure may be used as a negative busbar 20B, and the busbar 20 according to the fourth embodiment of the present disclosure may be used as a positive busbar 20A.

Although a substrate coupling part 26 and a holder coupling part 27 are omitted from the depictions and descriptions of the busbar 20 according to the third embodiment or the fourth embodiment of the present disclosure, the substrate coupling part 26 and the holder coupling part 27 may be formed in the busbar 20 according to the third embodiment or the fourth embodiment of the present disclosure.

Referring to FIGS. 21 to 23, the positive busbar 20A and the negative busbar 20B may be disposed to form a row extending in the left-right direction (x direction). In this case, the first bent portion 23 and the second bent portion 24 of the positive busbar 20A and the first bent portion 23 and the second bent portion 24 of the negative busbar 20B may be alternately disposed in the left-right direction (x direction). as such, the first bent portion 23 of the negative busbar 20B may be disposed between the first bent portion 23 and the second bent portion 24 of the positive busbar 20A.

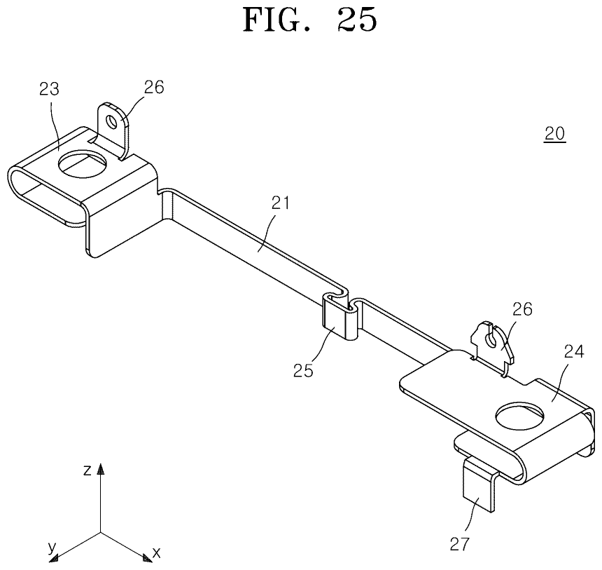

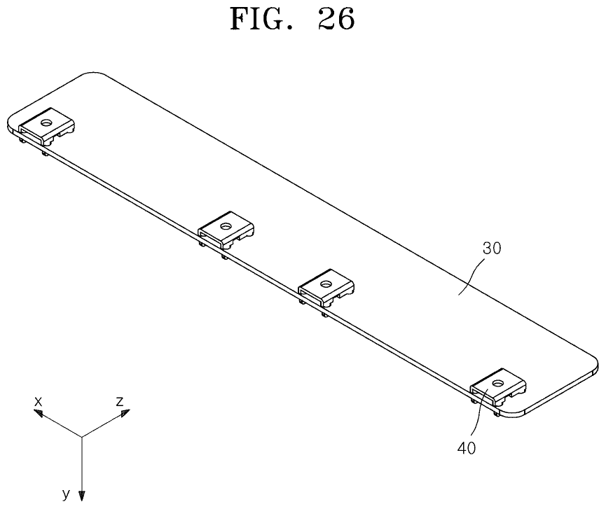

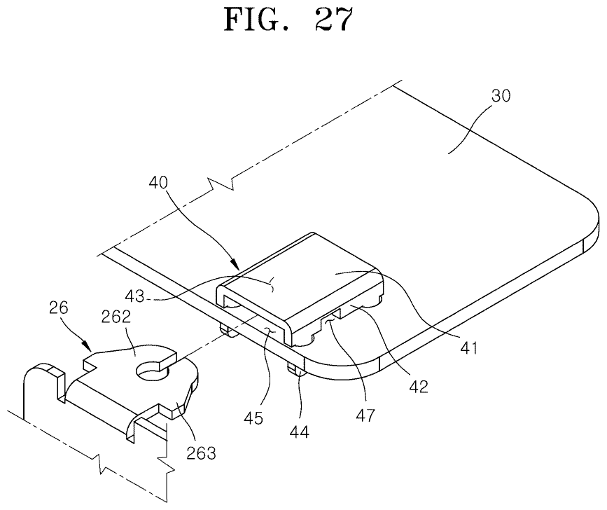

FIG. 24 is a schematic perspective view of a busbar according to a fifth embodiment of the present disclosure, and FIG. 25 is a schematic perspective view of a busbar according to a sixth embodiment of the present disclosure. FIG. 26 is a schematic perspective view illustrating a state in which a connecting member is coupled to a substrate according to the second embodiment of the present disclosure, and FIG. 27 is a view for describing an assembly structure of the busbar according to the fifth embodiment or the sixth embodiment of the present disclosure and the connecting member according to the second embodiment of the present disclosure.

Referring to FIG. 24, a substrate coupling part 26 of the busbar 20 according to the fifth embodiment of the present disclosure has a different shape than in the busbar 20 according to the first embodiment or the second embodiment of the present disclosure illustrated in FIGS. 9 and 19.

The substrate coupling part 26 of the busbar 20 according to the first embodiment or the second embodiment of the present disclosure has a structure in which the second hole 261 is formed, with the second fastening member 54 passing through the second hole 261. The substrate coupling part 26 of the busbar 20 according to the first embodiment or the second embodiment of the present disclosure may be coupled to the substrate 30 and the connecting member 40 by the second fastening member 54. Referring to FIGS. 24 to 27, the substrate coupling part 26 of the busbar 20 according to the fifth embodiment or the sixth embodiment of the present disclosure has a structure to be directly snap fit a connecting member.

Referring to FIG. 24, the substrate coupling part 26 having the snap fit fastening structure may be formed on both a first bent portion 23 and a second bent portion 24 as in the busbar 20 according to the fifth embodiment of the present disclosure. Referring to FIG. 25, the substrate coupling part 26 having the snap fit fastening structure may be formed on any one of a first bent portion 23 and a second bent portion 24 of the busbar 20 according to the sixth embodiment of the present disclosure.

The connecting member 40 according to the second embodiment of the present disclosure may have a structure capable of being snap fit coupled to the substrate coupling part 26. The connecting member 40 according to the second embodiment of the present disclosure may include a facing body 41, a protruding portion 42, a fixed leg 44, and an insertion hole 45 like the connecting member 40 according to the first embodiment of the present disclosure.

The connecting member 40 according to the second embodiment of the present disclosure may include a latch hole 47 in which a latch protrusion 263 is positioned. Such a configuration is an alternative to the first hole 46 to which the second fastening member 54 is fastened in the connecting member 40 according to the first embodiment of the present disclosure. The latch hole 47 may be formed to pass through the protruding portion 42 in the left-right direction (x direction) and may be open to the insertion space portion 43. The connecting member 40 according to the present disclosure may have a structure having all of the facing body 41, the protruding portion 42, the fixed leg 44, the insertion hole 45, the first hole 46, and the latch hole 47.

The substrate coupling part 26 having the snap fit fastening structure may include an elastic tong portion 262 and the latch protrusion 263.

The elastic tong portion 262 may have a tong shape of which a width is elastically variable in the left-right direction (x direction). The elastic tong portion 262 may be inserted into the insertion space portion 43 through the insertion hole 45 of the connecting member 40. That is, the elastic tong portion 262 may be slidably inserted into the insertion space portion 43 through the insertion hole 45. An upper portion of the elastic tong portion 262 may have a shape of which the width in the left-right direction (x direction) decreases upward such that the tong portion 262 is easily slidably inserted through the insertion hole 45. The upper portion of the elastic tong portion 262 may have a semicircular shape that is convex upward.

The latch protrusion 263 may be formed to protrude from the elastic tong portion 262 in the left-right direction (x direction). The latch protrusions 263 may have a triangular shape such that a width decreases upward and may be symmetric to each other on a right side portion and a left side portion of the elastic tong portion 262. In a state in which the elastic tong portion 262 is inserted into the insertion space portion 43, a pair of left and right latch protrusions 263 may be caught in the latch hole 47.

According to an embodiment of the present disclosure, as a busbar includes an electrode terminal of a first battery module, an electrode terminal of a second battery module, and a connecting part, which are formed using one sheet, and a connecting part for connection with a substrate, when a plurality of battery modules are electrically connected to the substrate using the busbar. The configuration provides for a slim structure. Thus, space utilization and workability of a battery pack are improved.

In addition, according to an embodiment of the present disclosure, as a bent portion is formed in a busbar, vibrations can be buffered due to an elastic force of the bent portion, and a stress of a load can be dispersed. Accordingly, breaking of the busbar can be prevented, and the durability of a battery pack can be improved.

In addition, according to an embodiment of the present disclosure, as a plurality of bent portions having shapes bent in one or more directions of an x direction, a y direction, and a z direction are formed, vibrations in multi-directions including the x direction, the y direction, and the z direction can be buffered, and a stress can be dispersed.

However, the effects obtainable through the present disclosure are not limited to the effects expressly described herein, and other technical effects that are not mentioned will be clearly understood by those skilled in the art from the disclosure.

While the present disclosure has been described with reference to embodiments shown in the drawings, these embodiments are merely illustrative and it should be understood that various modifications and equivalent other embodiments can be derived by those skilled in the art on the basis of the embodiments.

What is claimed is:

1. A battery pack comprising:
a first battery module;
a second battery module positioned in a first direction from the first battery module;
a bus bar including a bent portion having a bent shape, the bus bar being disposed to extend in the first direction, and the bus bar being electrically connected to an electrode terminal of the first battery module and an electrode terminal of the second battery module; and
a substrate extending from the first battery module and the second battery module in a second direction and coupled to the busbar.

2. The battery pack as claimed in claim 1, wherein each of the first battery module and the second battery module comprises:
one or more battery cells;
a housing in which the one or more battery cells are accommodated;
a busbar holder disposed in the second direction from the one or more battery cells; and
the electrode terminal that is electrically connected to the one or more battery cells, extends toward the busbar holder, is in contact with the busbar, and comprises a positive electrode terminal and a negative electrode terminal.

3. The battery pack as claimed in claim 2, wherein the busbar comprises:
a positive busbar that extends in the first direction and electrically connects the positive electrode terminal of the first battery module and the positive electrode terminal of the second battery module; and
a negative busbar that extends in the first direction and electrically connects the negative electrode terminal of the first battery module and the negative electrode terminal of the second battery module.

4. The battery pack as claimed in claim 1, wherein the busbar comprises:
a busbar body extending in the first direction;
a first bent portion formed by a first portion of the busbar body that is bent in the second direction, the first bent portion being in contact with the electrode terminal of the first battery module in the second direction;
a second bent portion formed by a second portion of the busbar body that is bent in the second direction, the second bent portion being in contact with the electrode terminal of the second battery module in the second direction;
a third bent portion between the first bent portion and the second bent portion, the third bent portion being formed by a third portion of the busbar body that is bent in a third direction; and
a substrate coupling part formed on at least one side of the first bent portion and the second bent portion to protrude in the second direction, the substrate coupling part being coupled to the substrate.

5. The battery pack as claimed in claim 4, wherein the busbar body comprises:
a first body that is located between the first bent portion and the third bent portion and extends in the first direction; and
a second body that is located between the second bent portion and the third bent portion and extends in the first direction,
wherein a separation space formed between the first body and the second body.

6. The battery pack as claimed in claim 4, wherein the first bent portion comprises:
a first flat portion continuously formed with the busbar body and formed in a shape that is flat in the first direction and the third direction;
a second flat portion that is disposed to face the first flat portion with a second distance therebetween in the second direction and is in contact with the electrode terminal of the first battery module; and
an elastic bent portion that is continuously formed between the first flat portion and the second flat portion and has a curved shape that is convex in the first direction or the third direction.

7. The battery pack as claimed in claim 6, wherein the first bent portion further comprises a fastening hole passing through the first flat portion and the second flat portion in the second direction and to which a first fastening member is fastened.

8. The battery pack as claimed in claim 7, wherein the first fastening member comprises:
a fastening body fastened to the first bent portion and the electrode terminal of the first battery module; and
a head having a width greater than a width of the fastening body,
wherein the fastening hole comprises:
a first fastening hole formed in the first flat portion and having a width that allows the head of the fastening body to pass through the first fastening hole; and
a second fastening hole formed in the second flat portion and having a width that is less than a width of the head of the fastening body.

9. The battery pack as claimed in claim 5, wherein the third bent portion comprises:
a bent end portion spaced a third distance from the first body and the second body in the third direction extending in the first direction;
a first curved portion continuously formed between the bent end portion and the first body and curved in the first direction; and
a second curved portion continuously formed between the bent end portion and the second body and curved in the first direction.

10. The battery pack as claimed in claim 9, wherein the first curved portion and the second curved portion are formed in S shapes and are symmetric to each other.

11. The battery pack as claimed in claim 9, wherein the first curved portion comprises:
a first semicircular curved portion continuously formed from the first body and having a curved shape that is convex in the first direction; and
a second semicircular curved portion continuously formed between the first semicircular curved portion and the bent end portion and having a curved shape that is convex in a direction opposite to the first direction.

12. The battery pack as claimed in claim 11, wherein each of the first semicircular curved portion and the second semicircular curved portion is curved in a semicircular shape having a diameter greater than or equal to two times and less than or equal to five times of a thickness of the busbar.

13. The battery pack as claimed in claim 5, wherein the third bent portion comprises:
a first curved arc portion continuously formed from the first body and having a curved portion that is convex in the first direction; and
a second curved arc portion continuously formed between the first curved arc portion and the second body and having a curved shape that is convex in a direction opposite to the first direction.

14. The battery pack as claimed in claim 4, wherein:
the busbar is formed from a bent board;
the busbar body is seated on the busbar holder of the first battery module and the busbar holder of the second battery module in the second direction such that a surface of the board extends in the third direction; and
at least one side of the first bent portion and the second bent portion is seated on at least one side of the electrode terminal of the first battery module and the electrode terminal of the second battery module in the second direction.

15. The battery pack as claimed in claim 14, wherein the busbar holder is supported and stood up by a width in the third direction of the third bent portion.

16. The battery pack as claimed in claim 6, further comprising a connecting member that is coupled to the substrate to thereby form an insertion space between the connecting member and the substrate, with the substrate coupling part being slidably inserted into the insertion space.

17. The battery pack as claimed in claim 16, wherein the connecting member comprises:
a facing body disposed to face the substrate in the third direction;
a protruding portion that protrudes from an edge portion of the facing body in the first direction toward the substrate and in which the insertion space portion is formed between the facing body and the substrate;
a plurality of fixed legs that protrude from the protruding portion toward the substrate and fitted to the substrate; and
an insertion hole that is formed to be open between the edge portion of the facing body in the second direction and the substrate and into which the substrate coupling part is inserted.

18. The battery pack as claimed in claim 17, wherein the connecting member further comprises a first hole that passes through the facing body and to which a second fastening member is fastened,
wherein the second fastening member passes through and is fastened to the first hole, a second hole formed in the substrate coupling part, and a third hole formed in the substrate.

19. The battery pack as claimed in claim 17, wherein the connecting member further comprises a latching hole formed to pass through the protruding portion in the first direction and open to the insertion space portion,
wherein the substrate coupling part comprises:
an elastic tong portion having a tong shape of which a width is elastically variable in the first direction, the elastic tong portion being inserted into the insertion space portion through the insertion hole; and
a latch protrusion protruding from the elastic tong portion in the first direction and caught in the latch hole with the elastic tong portion inserted into the insertion space portion.

20. The battery pack as claimed in claim 4, wherein the busbar further comprises a holder coupling part that protrudes from at least one side of the first bent portion and the second bent portion in a direction opposite to the second direction, the holder coupling part being fitted into a guide hole formed in at least one side of the busbar holder of the first battery module and the busbar holder of the second battery module.
